(19) United States
(12) Patent Application Publication
(10) Pub. No.: US 2023/0133046 A1
(43) Pub. Date: May 4, 2023

(54) MOVEMENT SUPPORT SYSTEM

(71) Applicant: TOYOTA JIDOSHA KABUSHIKI KAISHA, Toyota-shi Aichi-ken (JP)

(72) Inventor: Mashio Taniguchi, Toyota-shi Aichi-ken (JP)

(73) Assignee: TOYOTA JIDOSHA KABUSHIKI KAISHA, Toyota-shi Aichi-ken (JP)

(21) Appl. No.: 17/950,650

(22) Filed: Sep. 22, 2022

(30) Foreign Application Priority Data
Nov. 4, 2021 (JP) 2021-180652

(51) Int. Cl. B64C 39/02

(52) U.S. Cl. CPC B64C 39/024; B64C 2201/128; B64C 2201/145

(57) ABSTRACT

A movement support system is a movement support system in which a moving body follows a moving user to support the user, and includes an attribute information acquisition unit that acquires attribute information on the user, a mode setting unit that sets a mode of the moving body based on the attribute information, and a following support control unit that performs control of making the moving body follow the user and support the user based on the set mode.

### CROSS-REFERENCE TO RELATED APPLICATION

This application claims priority to Japanese Patent Application No. 2021-180652 filed on Nov. 4, 2021, incorporated herein by reference in its entirety.

### BACKGROUND

### 1. Technical Field

The present disclosure relates to a movement support system.

### 2. Description of Related Art

A following imaging system (control program) has been proposed in which a drone equipped with a camera flies so as to follow a moving person, such as a walker or a runner, and images the moving person. In this case, the position of the moving person and the position of the drone are each detected by the GPS and the drone flies so as to follow the moving person at a predetermined distance from the moving person.

A walking control device has been proposed that includes a drone mounted at an upper part of a helmet worn by a walker and exerts an external force on the walker by a propulsive force of the drone such that the walker moves along a predetermined course (see Japanese Unexamined Patent Application Publication No. 2021-025831 (JP 2021-025831 A)).

### SUMMARY

For the following imaging system and walking control device, no mention is made about control that takes an attribute of a moving person (whether the person is a walker or a runner etc.) into account. For example, no mention is made about changing the control according to whether the moving person is a walker or a runner, whether the moving person is a person with visual impairment or a person without visual impairment, etc.

For example, in the case of the following imaging system, it is conceivable to keep the drone farther away from the moving person when the moving person is a runner than when the moving person is a walker, as a runner moves at a higher speed than a walker, to thereby allow continuous imaging of the moving person. In the case of the walking control device, it is conceivable to reduce the propulsive force (external force) exerted by the drone when the moving person is a person with visual impairment, taking into account that a person with visual impairment cannot move quickly compared with a person without visual impairment.

Thus, a movement support system that provides support to a moving person is desired to perform appropriate movement support control according to an attribute of the moving person.

In view of this fact, the present disclosure aims to obtain a movement support system that provides appropriate support to a moving person according to an attribute of the moving person.

A movement support system according to a first aspect is a movement support system in which a moving body follows a moving user to support the user, and includes an attribute information acquisition unit that acquires attribute information on the user, a mode setting unit that sets a mode of the moving body based on the attribute information, and a following support control unit that makes the moving body follow the user and support the user based on the set mode.

In this movement support system, the attribute information acquisition unit acquires an attribute of the user, and the mode setting unit sets the mode of the moving body based on the attribute of the user. Accordingly, the following support control unit makes the moving body follow the user and support the user in the mode based on the attribute information on the user.

Thus, appropriate movement support according to the attribute of the user can be provided to the user.

A movement support system according to a second aspect is the movement support system according to the first aspect, wherein the attribute information may be at least one of whether the user is a walker or a runner and whether the user is a person with visual impairment or a person without visual impairment.

In this movement support system, the mode of the moving body is changed according to at least one of whether the user is a walker or a runner and whether the user is a person with visual impairment or a person without visual impairment. For example, in the case where the movement support is imaging a user who is a moving person, the moving body is made to follow the user at a greater distance when the user is a runner than when the user is a walker to thereby allow continuous imaging of the runner who moves at a higher speed than a walker.

Further, for example, the moving body is kept farther away from the user when the user is a person with visual impairment than when the user is a person without visual impairment to thereby reliably prevent the user who cannot visually recognize the moving body from colliding with the moving body.

A movement support system according to a third aspect is the movement support system according to the first or second aspect, wherein the moving body may be an unmanned aircraft.

When the moving body is an unmanned aircraft, the moving body can follow the user who is a moving person, regardless of road conditions (e.g., steps and stairs). Thus, when the moving body is an unmanned aircraft, the moving body exhibits excellence in following the user.

A movement support system according to a fourth aspect is the movement support system according to any one of the first to third aspects, wherein the support may be following the user by the moving body holding an article and handing the article from the moving body to the user.

In this movement support system, the user is supported as the moving body follows the user while holding an article and the article is handed (provided) from the moving body to the user.

For example, it is possible to follow a user who is strolling by the moving body holding a drink and provide the drink from the moving body to the user at a timing when the user gets thirsty. Thus, the user need not carry a drink while moving, for example, walking or running, and yet can take a drink at a timing when the user needs it.

Or when buying a drink to take out at a coffee shop etc., a user can walk away toward a destination without waiting at the coffee shop until the drink is ready, and then the moving body can follow the user and hand the drink to the user. In this case, the waiting time at the coffee shop can be eliminated.

A movement support system according to a fifth aspect is the movement support system according to the fourth aspect, wherein the moving body may include a holding part that holds an article, and a movable part capable of shifting the holding part toward the user.

In this movement support system, it is possible to hand an article from the moving body to a user who is moving by making the moving body follow the user while holding an article by the holding part and bringing the holding part close to the user by the movable part. Thus, for example, the moving body can be made to follow a runner while holding a supplemental food or a drink by the holding part of the moving body, so that the supplemental food or the drink can be provided (handed) from the moving body to the runner at a timing when the runner needs it.

A movement support system according to a sixth aspect is the movement support system according to the fifth aspect, wherein, when the attribute information is a person with visual impairment, the holding part may be shifted to a predetermined position that is a fixed position relative to the upper body of the user when the article is handed from the moving body to the user.

In this movement support system, when handing an article from the moving body to a user who is a person with visual impairment, as the user cannot visually recognize the article, the predetermined position that is a fixed position relative to the upper body of the user is set beforehand as a handing position. Thus, when handing an article, the holding part of the moving body moves to the predetermined position that is a fixed position relative to the upper body of the user, so that the user who is a person with visual impairment can reliably receive the article from the holding part.

A movement support system according to a seventh aspect is the movement support system according to the fifth or sixth aspect, wherein the moving body may be an unmanned aircraft, and the moving body may include: a first arm of which one end is mounted to the moving body and the other end is capable of shifting so as to approach the user; a holder that is mounted at the other end of the first arm and capable of holding the article; a second arm of which one end is mounted to the moving body and the other end is capable of shifting toward the opposite side from the first arm as seen in a plan view; and a counterweight mounted at the other end of the second arm.

In this movement support system, the first arm mounted on the moving body is shifted so as to bring the holder mounted at the leading end of the first arm close to the user. Thus, this moving body exhibits excellence in handing an article as the user receives the article from the holder that has come close to the user.

In this case, the second arm with the counterweight mounted at the leading end is shifted in the opposite direction from the first arm as seen in a plan view so as to cancel the moment occurring on the moving body, which is an unmanned aircraft, due to movement of the first arm, the holder, and the article relative to the moving body. Thus, the moment occurring on the moving body while handing the article is reduced, which makes it easier to control the posture of the moving body while handing the article.

This movement support system can provide appropriate support to a moving person according to an attribute of the moving person.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram showing the hardware configuration of a movement support system according to one embodiment;

FIG. 2 is a view schematically showing the configuration of a drone according to one embodiment;

FIG. 3 is a plan view showing a holder of the drone according to one embodiment;

FIG. 4 is a block diagram showing the hardware configuration of the drone according to one embodiment;

FIG. 5 is an illustration schematically illustrating self-localization of the drone according to one embodiment;

FIG. 6 is a diagram showing the functional configuration of a drone control device according to one embodiment;

FIG. 7 is a block diagram showing the hardware configuration of a server according to one embodiment;

FIG. 8 is a block diagram showing the functional configuration of a server control device according to one embodiment;

FIG. 9 is a block diagram showing the hardware configuration of a mobile terminal according to one embodiment;

FIG. 10 is a diagram showing the functional configuration of a terminal control device according to one embodiment;

FIG. 11 is a flowchart showing one example of the flow of processing in the mobile terminal according to one embodiment;

FIG. 12 is a flowchart showing one example of the flow of processing in the server according to one embodiment;

FIG. 13 is a flowchart showing one example of the flow of a following flight process of the drone according to one embodiment;

FIG. 14 is a flowchart showing one example of the flow of an avoidance flight process of the drone according to one embodiment;

FIG. 15 is a flowchart showing one example of the flow of a handing process of the drone according to one embodiment;

FIG. 16 is a schematic view illustrating an avoidance process of the drone according to one embodiment; and

FIG. 17 is a schematic view illustrating the handing process of the drone according to one embodiment.

### DETAILED DESCRIPTION OF EMBODIMENTS

### Embodiment

A movement support system 10 according to one embodiment will be described with reference to the drawings.

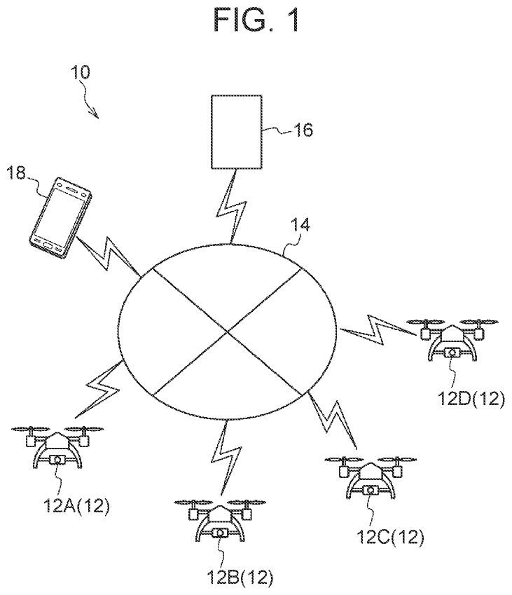

As shown in FIG. 1, the movement support system 10 includes a plurality of drones 12 (when distinctions are made among the individual drones, these drones will be referred to as drones 12A to 12D), a server 16, and a mobile terminal 18 of a user U that are connected to one another through a network 14.

The drone 12 corresponds to the “moving body” and the “unmanned aircraft.” Basically, the drone 12 of this embodiment flies autonomously when (the position of) the user U who is an object to be followed is confirmed.

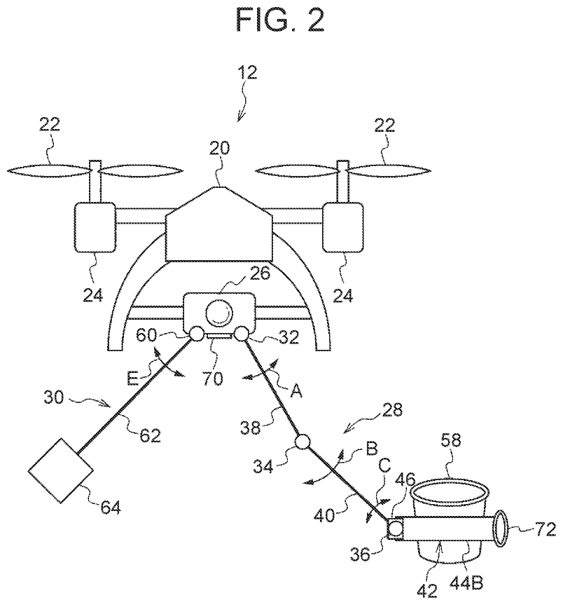

As shown in FIG. 2, the drone 12 has a plurality of rotors 22 provided at an upper part of a machine main body 20. The rotors 22 are driven by their respective rotor motors 24 to control the flight of the drone 12.

The drone 12 has a mounting part 26 provided at a lower central portion of the machine main body 20. A first arm 28 and a second arm 30 are mounted on a bottom surface of the mounting part 26.

The first arm 28 has a first joint 32, a second joint 34, and a third joint 36. A first link 38 is disposed between the first joint 32 and the second joint 34, and a second link 40 is disposed between the second joint 34 and the third joint 36.

A holder 42 is mounted at one end of the second link 40 (on the side of the third joint 36) through the third joint 36. The holder 42 corresponds to the “holding part.”

As shown in FIG. 2, the first joint 32, the second joint 34, and the third joint 36 allow the first link 38, the second link 40, and the holder 42 to rotate (shift) in the same direction in one plane (see arrow A to arrow C in FIG. 2).

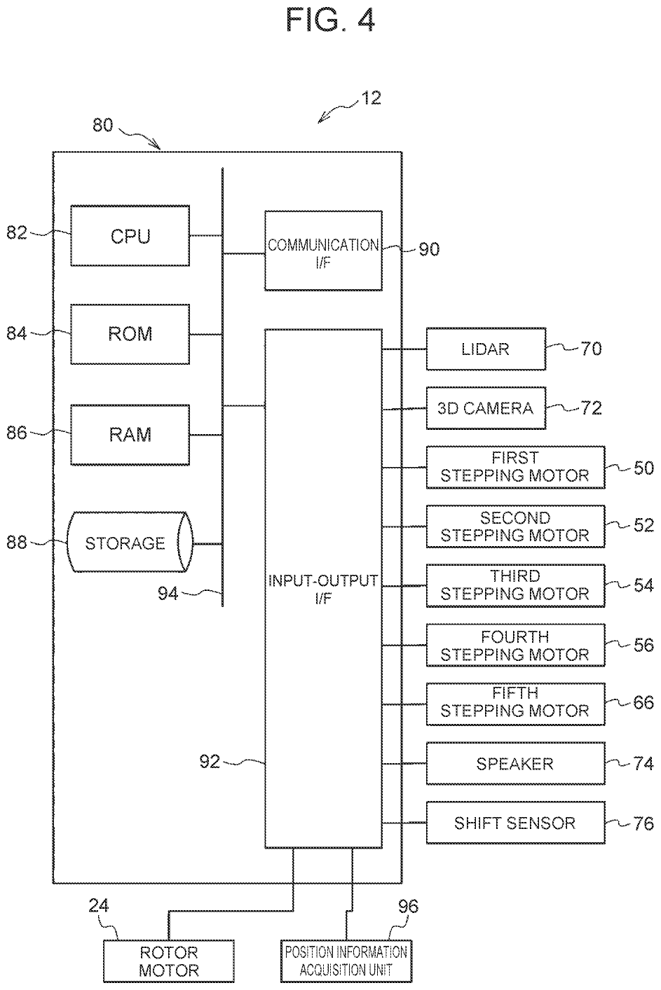

While this is not shown in FIG. 2, the first joint 32, the second joint 34, and the third joint 36 are each provided with an actuator. Each actuator has a stepping motor (see a first stepping motor 50, a second stepping motor 52, and a third stepping motor 54 in FIG. 4). As driving of these stepping motors is controlled, the first joint 32, the second joint 34, and the third joint 36 are driven to rotate, allowing the holder 42 provided at a leading end of the first arm 28 to shift while maintaining a horizontal state.

The first arm 28, the first stepping motor 50, and the second stepping motor 52 correspond to the “movable part.”

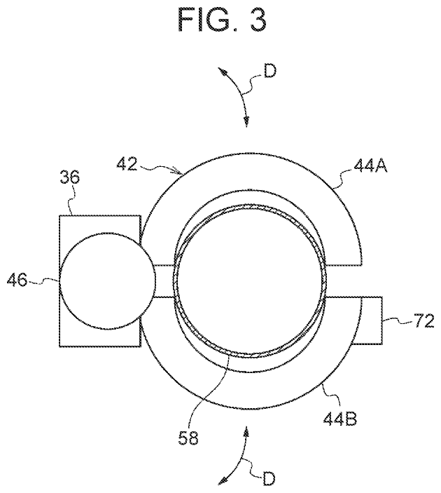

On the other hand, as shown in FIG. 3, the holder 42 mounted at the leading end of the first arm 28 is composed of a pair of arms 44A, 44B that have a substantially semicircular shape as seen in a plan view and are each supported at one end by the fourth joint 46.

As shown in FIG. 3, the fourth joint 46 has a rotational axis that extends in a direction orthogonal to rotational axes of the first joint 32, the second joint 34, and the third joint 36 and can shift (rotate) in a plane orthogonal to the aforementioned one plane (see arrow D in FIG. 3).

While this is not shown in FIG. 2 and FIG. 3, the fourth joint 46 is also provided with an actuator. The actuator has a fourth stepping motor 56 (see FIG. 4), and as driving of the fourth stepping motor 56 is controlled, the arms 44A, 44B of the holder 42 are moved toward or away from each other in the direction of arrow D around the fourth joint 46. Thus, a drink cup 58 etc. can be held in the holder 42 (between the arms 44A, 44B) or the cup 58 etc. can be taken out of the holder 42.

On the other hand, the second arm 30 has a fifth joint 60 and a third link 62. One end of the third link 62 is held through the fifth joint 60 provided on the bottom surface of the mounting part 26. The fifth joint 60 has a rotational axis in the same direction as the first joint 32 and the second joint 34 and can shift (rotate) in one plane (see the direction of arrow E in FIG. 2). A counterweight 64 is mounted at an end of the third link 62 on the opposite side from the fifth joint 60. While this is not shown in FIG. 2, the fifth joint 60 is also provided with an actuator. The actuator has a fifth stepping motor 66 (see FIG. 4).

As driving of the fifth stepping motor 66 is controlled, the fifth joint 60 is driven to rotate, allowing the counterweight 64 provided at a leading end of the fourth link 62 to shift in the direction of arrow E. Thus, the second arm 30 is configured to be able to shift in the opposite direction from the first arm 28 as seen in a plan view.

Further, a solid light detection and ranging (LIDAR) 70 is provided on the bottom surface of the mounting part 26 and can acquire information on the surroundings of the drone 12 across a 360-degree range.

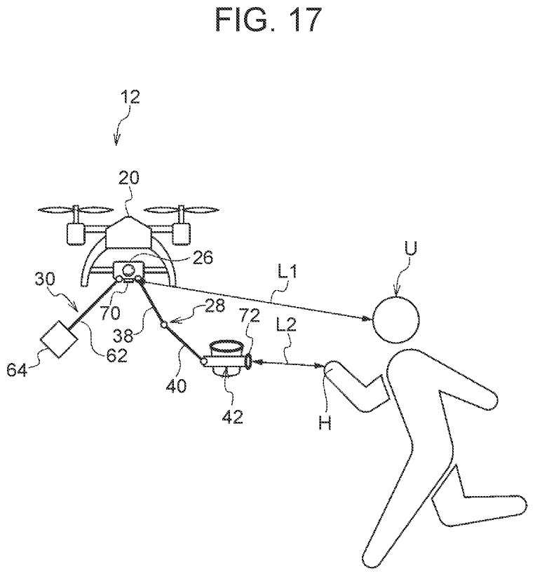

As shown in FIG. 2 and FIG. 3, a 3D camera 72 is mounted at a leading end of the arm 44B of the holder 42 and can detect a distance L2 between the holder 42 and a hand H of the user U as will be described later (see FIG. 17).

While this is not shown in FIG. 2 and FIG. 3, the drone 12 is further provided with a speaker 74 (see FIG. 4).

While this is not shown in FIG. 2 and FIG. 3, a shift sensor 76 is mounted on the holder 42 of the drone 12 (see FIG. 4). The shift sensor 76 detects an amount of shift of the arms 44A, 44B in an up-down direction. When an amount of upward shift of the arms 44A, 44B becomes equal to or larger than a threshold value, it is detected that the user U has held the cup 58 containing a drink that is grasped (held) by the holder 42.

Next, the hardware configuration of the drone 12 will be described with reference to FIG. 4.

The drone 12 has a drone control device 80.

As shown in FIG. 4, the drone control device 80 includes, in its configuration, a central processing unit (CPU; processor) 82, a read-only memory (ROM) 84, a random-access memory (RAM) 86, a storage 88, a communication interface (communication I/F) 90, and an input-output interface (input-output I/F) 92. These components are communicably connected to one another through a bus 94.

The CPU 82 is a central arithmetic processing unit, and executes various programs and controls parts. Specifically, the CPU 82 reads a program from the ROM 84 or the storage 88 and executes the program using the RAM 86 as a workspace. The CPU 82 performs control of the aforementioned components and various arithmetic processes in accordance with programs recorded in the ROM 84 or the storage 88.

The ROM 84 stores various programs and various pieces of data. The RAM 86 temporarily stores programs or data as a workspace. The storage 88 is formed by a hard disk drive (HDD) or a solid-state drive (SSD) and stores various programs and various pieces of data including an operating system. In this embodiment, programs for performing processes, various pieces of data, etc. are stored in the ROM 84 or the storage 88.

The communication interface (communication I/F) 90 is an interface for the movement support system 10 to communicate with other devices, and a standard such as Ethernet (R), LTE, FDDI, Wi-Fi (R), or Bluetooth (R) is used.

The rotor motors 24, the first stepping motor 50, the second stepping motor 52, the third stepping motor 54, the fourth stepping motor 56, the fifth stepping motor 66, the lidar 70, the 3D camera 72, the speaker 74, and the shift sensor 76 are connected to the input-out interface (input-output I/F) 92. While other sensors, actuators, etc. are also connected to the input-output interface 92, these are not shown in this embodiment.

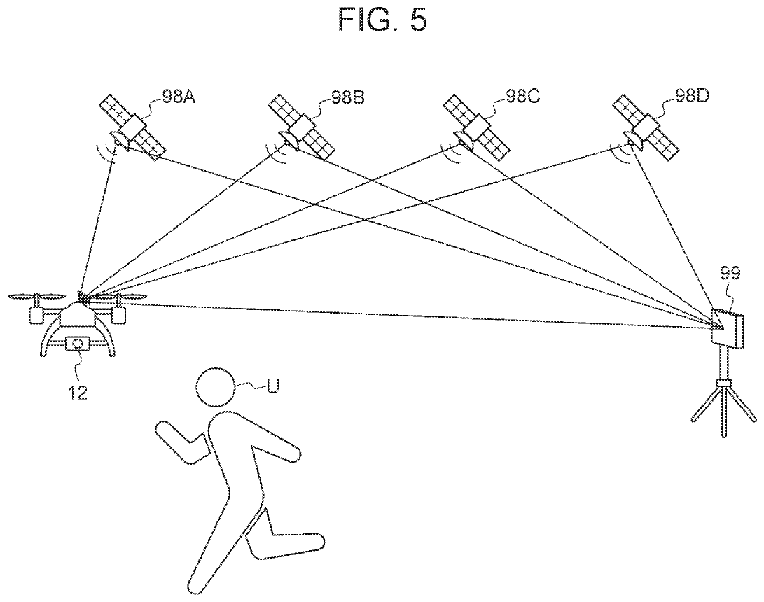

Further, as shown in FIG. 4, a position information acquisition unit 96 functions to receive signals from a real-time kinematic global navigation satellite system (RTK-GNSS). Specifically, as shown in FIG. 5, the position information acquisition unit 96 functions to receive signals from at least three or more (here, four) GNSS satellites 98A to 98D and receive a correction signal from a reference station 99 of which the position is confirmed beforehand.

Functional Configuration of Drone

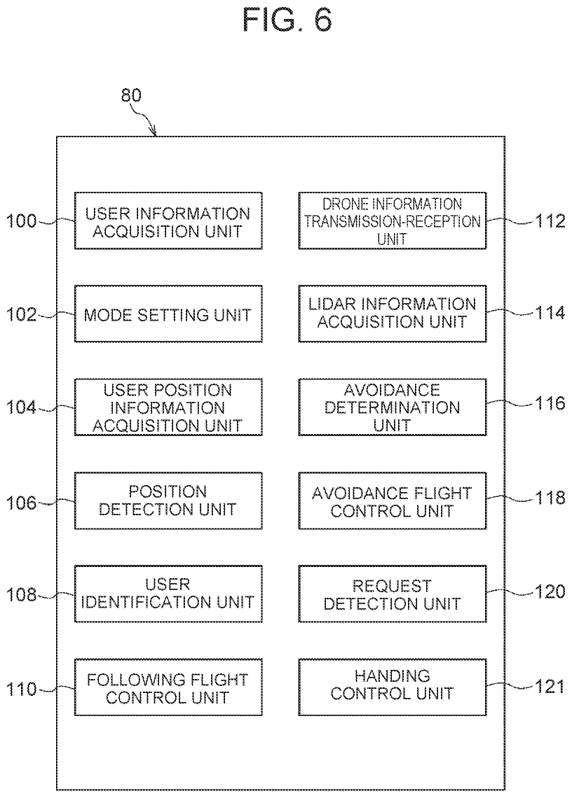

The drone control device 80 of the drone 12 realizes various functions using the hardware resources described above. The functional configuration realized by the drone control device 80 will be described with reference to FIG. 6.

The drone control device 80 of the drone 12 includes, in its functional configuration, a user information acquisition unit 100, a mode setting unit 102, a user position information acquisition unit 104, a position detection unit 106, a user identification unit 108, a following flight control unit 110, a drone information transmission-reception unit 112, a lidar information acquisition unit 114, an avoidance determination unit 116, an avoidance flight control unit 118, a request detection unit 120, and a handing control unit 121. Each unit in this functional configuration is realized as the CPU 82 reads and executes a program stored in the ROM 84 or the storage 88.

The following flight control unit 110 and the handing control unit 121 correspond to the “movement support control unit.”

The user information acquisition unit 100 functions to acquire attribute information on the user from user information, to be described later, that is transmitted from the server 16.

The mode setting unit 102 functions to set a mode based on the attribute information on the user U.

Modes include a person-with-visual-impairment mode, a person-without-visual-impairment mode, a walker mode, a runner mode, a right hand mode, and a left hand mode. These modes are modes corresponding respectively to pieces of attribute information on the user U (information about whether the user U is a person with visual impairment or not, whether the user U is a walker or a runner, and whether the dominant hand of the user U is the right hand or the left hand).

The following flight control and the handing control of the drone 12 when each mode is selected will be described later.

The user position information acquisition unit 104 functions to acquire position information on the user U (mobile terminal 18) by receiving position information on the mobile terminal 18 of the user U from the mobile terminal 18.

The position detection unit 106 functions to detect a current position of the drone 12 (perform self-localization) based on signals received from the GNSS satellites 98A to 96D and a correction signal received from the reference station 99 that have been acquired by the position information acquisition unit 96.

The user identification unit 108 functions to identify the user U in surroundings information on the drone 12 detected by the lidar 70 based on a relationship between the position information on the user U (mobile terminal 18) and the current position of the drone 12.

The following flight control unit 110 functions to control the flight of the drone 12, based on the mode set based on the attribute information on the user U, such that the drone 12 follows the user U who is an object to be followed, with a distance L1 between the user U and the drone 12 kept within a set range (A<L1<B).

For example, in the case of the person-with-visual-impairment mode, since the user U who is a person with visual impairment cannot visually recognize the drone 12, the numerical values A, B defining the set range of the distance L1 are set to be larger (set so as to keep the drone 12 farther away from the user U) than in the case of the person-without-visual-impairment mode.

In the case of the runner mode, since the user U who is a runner moves at a higher speed and swings his or her arms to a greater extent than a walker, the numerical values A, B defining the set range of the distance L1 during a following flight are set to be larger than in the case of the walker mode (the drone 12 is kept farther away from the user U than in the case of the walker mode).

Further, in the case of the left hand mode, to quickly shift the holder 42 to a front side of the left hand of the user U that is the dominant hand when handing an article, the drone 12 is controlled so as to fly on the side of the dominant hand (left hand) of the user U during a following flight.

The drone information transmission-reception unit 112 functions to successively transmit and receive drone information including position information on the drone 12 obtained by self-localization in the position detection unit 106, and speed information and acceleration information on the drone 12 to and from other drones with which the drone 12 has been paired (set to be able to transmit and receive information) at the time of shipment or provision of a service by Bluetooth (R) or the like.

The lidar information acquisition unit 114 functions to detect the distances between the drone 12 and other persons than the user U and other drones that are present in the vicinity of the drone 12 based on surroundings information on the drone 12 detected by the lidar 70.

The avoidance determination unit 116 functions to determine whether to change the following flight control or the handing control, to be described later, to avoidance flight control based on the risk of the drone 12 colliding with other persons than the user U or other drones.

The avoidance flight control unit 118 functions to interrupt the following flight control or the handing control and make the drone 12 fly at a predetermined distance or a greater distance from the other drones or persons other than the user U with whom the drone 12 may come into contact.

The request detection unit 120 functions to detect that a drink handing request has been received from the user U by detecting that the user U has assumed a predetermined pose from an image captured by the 3D camera 72.

To hand the cup 58 (drink) etc. held by the holder 42 to the user U, the handing control unit 121 functions to shift the holder 42 mounted at the leading end of the first arm 28 to a position a few centimeters away from the hand H of the user U based on detection results of the lidar 70 and the 3D camera 72 and hand the drink cup 58 held by the holder 42 to the user U.

Further, the handing control unit 121 functions to announce, “Please take the cup,” to the user U from the speaker 74 and, when detecting that the user U has held the cup 58 by a detection signal from the shift senor 76, drive the fourth stepping motor 56 to move the arms 44A, 44B of the holder 42 away from each other and thereby allow the cup 58 to be taken out of the holder 42.

Also for the handing control, a different type of control is performed according to the selected mode.

For example, in the case of the person-with-visual-impairment mode, since the user U who is a person with visual impairment has difficulty visually recognizing the holder 42 (cup 58), a predetermined position that is a fixed position relative to the upper body of the user U is set as a position at which the cup 58 is received from the holder 42. In the case of the person-with-visual-impairment mode, therefore, the handing control of moving the holder 42 to the predetermined position that is a fixed position relative to the upper body of the user U, and not relative to the hand H of the user U, is performed.

In the case of the runner mode, since the user U swings his or her arms fast and to a great extent, control is performed to move the holder 42 to a position a few centimeters away from a hand position at which the hand H of the user U is located farthest forward as the user U swings his or her arm. Further, in the case of the runner mode, since the user U who is a runner moves at a higher speed, the handing control is performed while the drone 12 is made to fly alongside the user U.

Moreover, in the case where the dominant hand of the user U is known (e.g., in the case of the left hand mode), the handing control is performed so as to position the holder 42 on a front side of the dominant hand (left hand) when handing an article.

Server

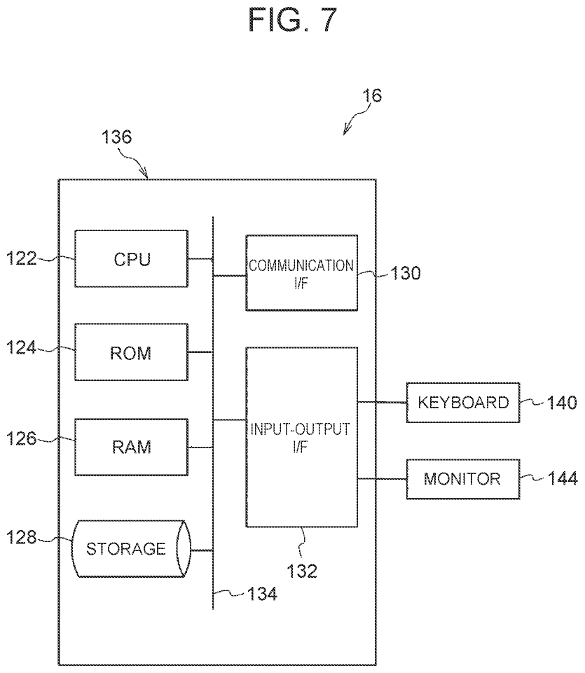

FIG. 7 shows the hardware configuration of the server 16. The hardware configuration of a server control device 136 of the server 16 is similar to that of the drone control device 80 of the drone 12. Therefore, only differences from the drone control device 80 will be described while detailed description will be omitted.

As shown in FIG. 7, the server control device 136 includes, in its configuration, a central processing unit (CPU; processor) 122, a read-only memory (ROM) 124, a random-access memory (RAM) 126, a storage 128, a communication interface (communication I/F) 130, and an input-output interface (input-output I/F) 132. These components are communicably connected to one another through a bus 134.

A keyboard 140 and a monitor 144 are connected to the input-output OF 132.

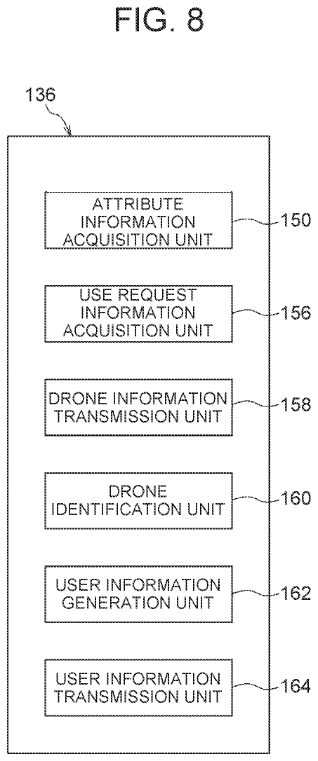

The server control device 136 of the server 16 realizes various functions using the aforementioned hardware resources. The functional configuration realized by the server control device 136 will be described with reference to FIG. 8.

The server control device 136 of the server 16 has, in its functional configuration, an attribute information acquisition unit 150, a use request information acquisition unit 156, a drone information transmission unit 158, a drone identification unit 160, a user information generation unit 162, and a user information transmission unit 164.

The attribute information acquisition unit 150 functions to store attribute information etc. on the user U input from the keyboard 140 by a person who inputs information (e.g., a service provider or the user). Examples of the attribute information include whether the user U is a walker or a runner, whether the user U is a person with visual impairment or not, and information on the dominant hand of the user U. The attribute information may include gender, age, height, etc. These pieces of attribute information are stored in the ROM 124 or the storage 128 in association with a user ID.

The use request information acquisition unit 156 functions to identify (the user ID of) the user U who requests to use the service based on use request information received from the mobile terminal 18 of the user U.

The drone information transmission unit 158 functions to transmit information on one or more available drones to the mobile terminal 18 of the user U. Information on the drones includes a stand-by position of the drone and an article that the drone can hold, for example, whether the drone is for delivering a drink or holding a load.

The drone identification unit 160 functions to identify the drone 12 to be used by the user U by receiving selected drone information about the selected drone 12 from the mobile terminal 18 of the user U.

The user information generation unit 162 functions to generate user information including attribute information (associated with the user ID) on the user U who is a person requesting to use the service.

The user information transmission unit 164 functions to transmit the user information to the drone 12 identified by the drone identification unit 160.

Mobile Terminal

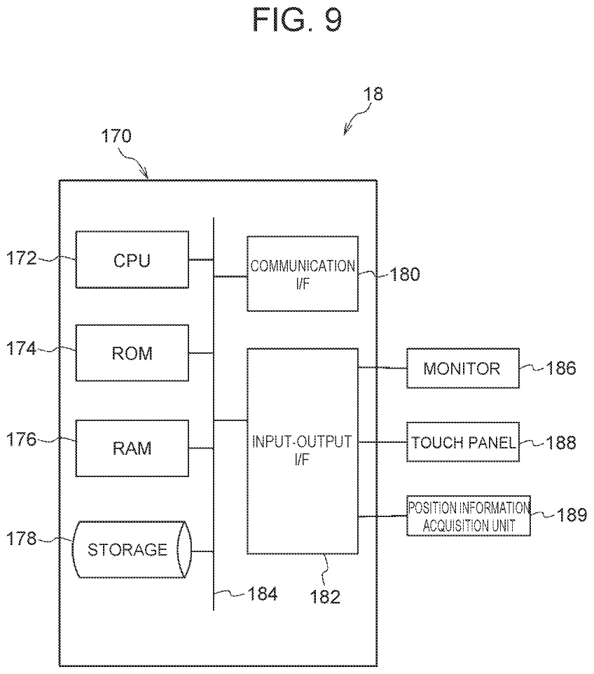

FIG. 9 shows the hardware configuration of the mobile terminal 18. The hardware configuration of a terminal control device 170 of the mobile terminal 18 is similar to that of the drone control device 80 of the drone 12. Therefore, only differences from the drone control device 80 will be described while detailed description will be omitted.

As shown in FIG. 9, the terminal control device 170 of the mobile terminal 18 includes, in its configuration, a central processing unit (CPU; processor) 172, a read-only memory (ROM) 174, a random-access memory (RAM) 176, a storage 178, a communication interface (communication I/F) 180, and an input-output interface (input-output I/F) 182. These components are communicably connected to one another through a bus 184.

A monitor 186, a touch panel 188, and a position information acquisition unit 189 are connected to the input-output I/F 132. Like the drone 12, the position information acquisition unit 189 functions to receive signals from the GNSS satellites 98A to 98D by the RTK-GNSS and a correction signal from the reference station 99.

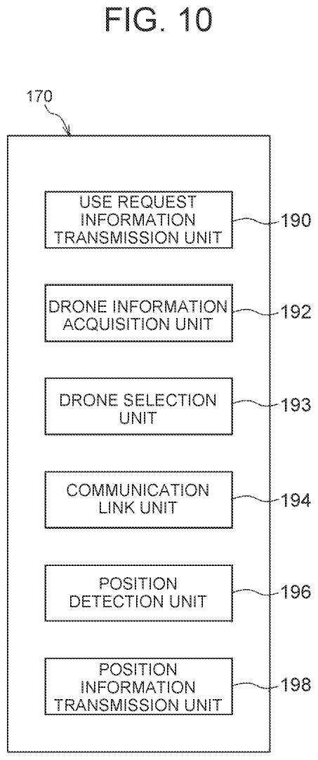

The terminal control device 170 of the mobile terminal 18 realizes various functions using the aforementioned hardware resources. The functional configuration realized by the terminal control device 170 will be described with reference to FIG. 10.

The terminal control device 170 of the mobile terminal 18 has, in its functional configuration, a use request information transmission unit 190, a drone information acquisition unit 192, a drone selection unit 193, a communication link unit 194, a position detection unit 196, and a position information transmission unit 198.

The use request information transmission unit 190 functions such that, when an application for the movement support service stored in the ROM 174 or the storage 178 of the mobile terminal 18 is started, use request information including user ID information etc. is transmitted to the server 16 through the network 14.

The drone information acquisition unit 192 functions to acquire information on available drones transmitted form the server 16 and display the available drones on the monitor 186.

The drone selection unit 193 functions such that, when a drone 12 to be used is selected from the available drones displayed on the monitor 186, selected drone information is transmitted to the server 16.

The communication link unit 194 functions such that, when a drone 12 to be used is selected from the available drones displayed on the monitor 186, the mobile terminal 18 and the selected drone 12 are paired with each other (set to be communicable) by Bluetooth (R).

The position detection unit 196 functions to detect the position of the mobile terminal 18 (perform self-localization) based on signals from the GNSS satellites 98A to 98D and a correction signal from the reference station 99.

The position information transmission unit 198 functions to transmit current position information on the mobile terminal 18 to the drone 12.

Workings

Next, the workings of this embodiment will be described. A case where the user U takes a drink while running by using the movement support service will be described. Unless otherwise noted, the user U in the description of the workings is a person without visual impairment and a runner.

Processing in Mobile Terminal

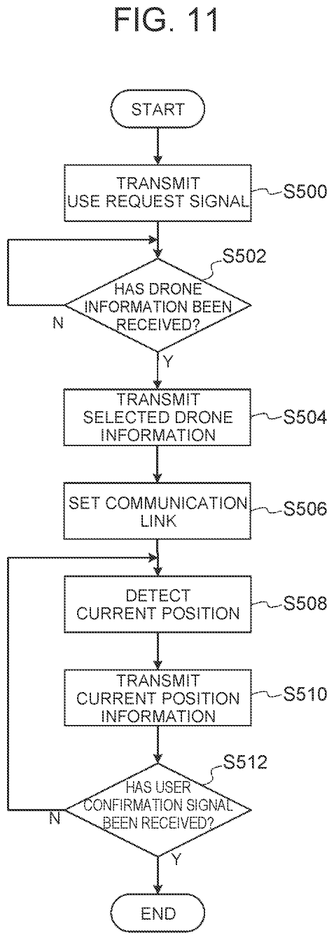

Processing in the mobile terminal 18 will be described using the flowchart shown in FIG. 11. This processing is executed as the CPU 172 reads a program from the ROM 174 or the storage 178 and executes the program by decompressing it in the RAM 176.

When the movement support program stored in the terminal control device 170 is started as the user U operates the mobile terminal 18, in step S500, the CPU 172 of the terminal control device 170 transmits use request information including information on the ID number of the user U to the server 16 through the network 14 by the function of the use request information transmission unit 190.

Next, in step S502, the CPU 172 of the terminal control device 170 determines whether the user U has received drone information about one or more available drones from the server 16 by the function of the drone information acquisition unit 192.

When it is determined in the negative in step S502, the CPU 172 waits in step S502 until it is determined in the affirmative.

On the other hand, when it is determined in the affirmative in step S502, one or more available drones are displayed on the monitor 186 of the mobile terminal 18 based on the acquired drone information, and the user U selects a drone to be used by the touch panel 188.

As a result, in step S504, the CPU 172 of the terminal control device 170 transmits information on the drone selected by the user U, i.e., selected drone information to the server 16 by the function of the drone selection unit 193.

Subsequently, in step S506, the CPU 172 of the terminal control device 170 is set to be communicable with the selected drone 12 by the function of the communication link unit 194. For example, the mobile terminal 18 and the drone 12 are paired with each other (set to be communicable) by Bluetooth (R).

Next, in step S508, the CPU 172 of the terminal control device 170 detects the current position of the mobile terminal 18 (performs self-localization) based on signals from the GNSS satellites 98A to 98D and a correction signal from the reference station 99 by the function of the position detection unit 196.

Subsequently, in step S510, the CPU 172 of the terminal control device 170 transmits current position information on the mobile terminal 18 to the selected drone 12 by the function of the position information transmission unit 198.

Further, in step S512, the CPU 172 of the terminal control device 170 determines whether a user confirmation signal has been received from the drone 12.

When it is determined in the negative in step S512, the CPU 172 returns to step S508.

When it is determined in the affirmative in step S512, the CPU 172 ends the process.

Processing in Server

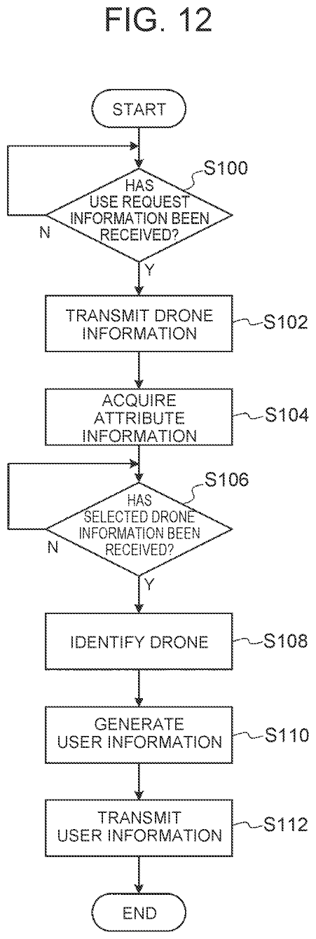

Processing in the server 16 will be described with reference to the flowchart of FIG. 12. This processing is executed as the CPU 122 reads a program from the ROM 124 or the storage 128 and executes the program by decompressing it in the RAM 126.

In step S100 of FIG. 12, the CPU 122 of the server control device 136 determines whether use request information has been received from the mobile terminal 18 by the function of the use request information acquisition unit 156.

When it is determined in the negative in step S100, the CPU 122 waits until use request information is received in step S100.

On the other hand, when it is determined in the affirmative in step S100, in step S102, the CPU 122 of the server control device 136 transmits information on one or more drones available to the user U who has requested to use the service to the mobile terminal 18 by the function of the drone information transmission unit 158.

Next, in step S104, the CPU 122 of the server control device 136 reads attribute information (associated with the user ID) on the user U who is a person requesting to use the service that is stored in the ROM 124 or the storage 128 in association with the user ID by the function of the attribute information acquisition unit 150.

Examples of the attribute information include whether the user U is a person with visual impairment or not and whether the user U is a walker or a runner. In this embodiment, the movement support system 10 is configured such that the user or the service provider inputs the attribute information on each user into the server 16 beforehand, but the present disclosure is not limited thereto. The movement support system 10 may instead be configured such that, at the start-up of the application, the user U inputs the attribute information into an input screen using the mobile terminal 18 of the user U and that thereby the attribute information on the user U is transmitted from the mobile terminal 18 to the server 16.

Next, in step S106, the CPU 122 of the server control device 136 detects whether selected drone information has been acquired from the mobile terminal 18 of the user U by the function of the drone identification unit 160.

When it is determined in the negative in step S106, the CPU 122 waits until selected drone information is received in step S106.

On the other hand, when it is determined in the affirmative in step S106, the CPU 122 moves to step S108.

In step S108, the CPU 122 of the server control device 136 identifies the drone 12 selected (to be used) by the user U based on the selected drone information by the function of the drone identification unit 160.

Subsequently, in step S110, the CPU 122 of the server control device 136 generates user information including the attribute information on the user U by the function of the user information generation unit 162.

Finally, in step S112, the CPU 122 of the server control device 136 transmits the generated user information to the identified drone 12 by the function of the user information transmission unit 164.

Processing in Drone

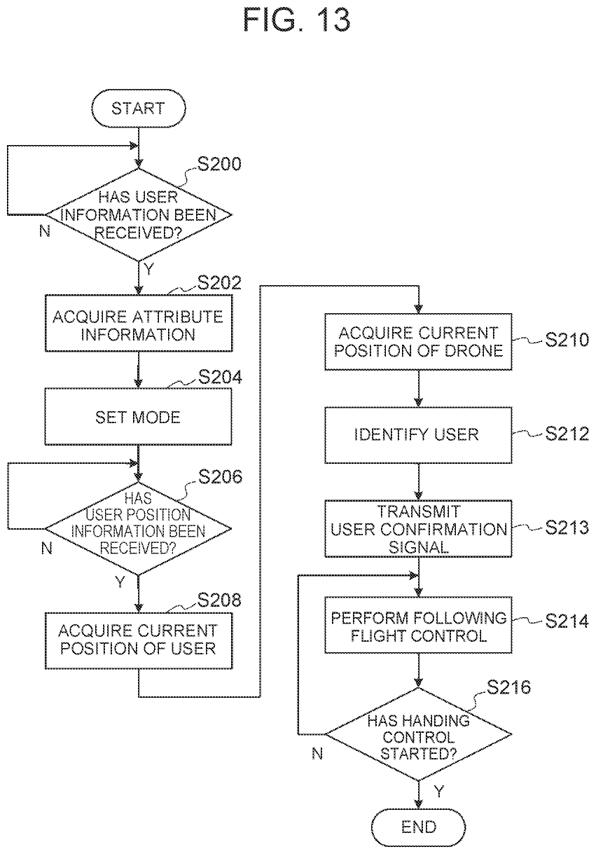

Processing in the drone 12 constituting a part of the movement support system 10 (movement support by the drone 12) will be described with reference to the flowcharts of FIG. 13 to FIG. 15. First, a following flight process of the drone 12 will be described with reference to the flowchart of FIG. 13.

Following Flight Process

In step S200 of FIG. 13, the CPU 82 of the drone control device 80 of the drone 12 determines whether user information has been received from the server 16 by the function of the user information acquisition unit 100.

When it is determined in the negative in step S200, the CPU 82 waits until user information is received in step S200.

When it is determined in the affirmative in step S200, in step S202, the CPU 82 of the drone control device 80 acquires attribute information on the user U by the function of the user information acquisition unit 100.

Next, in step S204, the CPU 82 of the drone control device 80 sets the mode based on the attribute information on the user U by the function of the mode setting unit 102.

For example, when the attribute information on the user U is a person with visual impairment, a person without visual impairment, a walker, or a runner, the person-with-visual-impairment mode, the person-without-visual-impairment mode, the walker mode, or the runner mode is respectively set. When the attribute information on the user U indicates that the dominant hand of the user U is the left hand or the right hand, the left hand mode or the right hand mode is set. When there is a plurality of pieces of attribute information on the user U, for example, when the attribute information on the user U is a person with visual impairment and a runner, both the person-with-visual-impairment mode and the runner mode are set, and the following flight control and the handing control, to be described later, are executed based on both the modes. However, when the person-with-visual-impairment mode and the runner mode conflict with each other, the person-with-visual-impairment mode is prioritized. Thus, when the person-with-visual-impairment mode and another mode conflict with each other, the person-with-visual-impairment mode is prioritized.

Next, in step S206, the CPU 82 of the drone control device 80 determines whether current position information on the mobile terminal 18 of the user U has been received from the mobile terminal 18 by the function of the user position information acquisition unit 104.

When it is determined in the negative in step S206, the CPU 82 waits until current position information on the mobile terminal 18 is received in step S206.

When it is determined in the affirmative in step S206, the CPU 82 moves to step S208.

In step S208, the current position of the mobile terminal 18 (user U) is acquired from the current position information.

Subsequently, in step S210, the CPU 82 of the drone control device 80 detects the current position of the drone 12 (performs self-localization) based on signals from the GNSS satellites 98A to 98D and a correction signal from the reference station 99 by the function of the position detection unit 106.

Next, in step S212, the CPU 82 of the drone control device 80 identifies the user U in surroundings information detected by the lidar 70 from the positional relationship between the current position of the drone 12 and the current position of the user U by the function of the user identification unit 108.

Further, in step S213, the CPU 82 of the drone control device 80 transmits a user confirmation signal showing that the user U has been identified in the surroundings information detected by the lidar 70 to the mobile terminal 18 of the user U by the function of the user identification unit 108.

In step S214, the CPU 82 of the drone control device 80 performs the following flight control of the drone 12 based on the selected mode by the function of the following flight control unit 110.

Specifically, the CPU 82 of the drone control device 80 controls the flight (performs the following flight control) of the drone 12 by the function of the following flight control unit 110 such that the drone 12 approaches the user U until the distance L1 between the drone 12 and the user U detected by the lidar 70 decreases to be within the predetermined range (A<L1<B) and that thereafter the distance L1 is kept within the predetermined range (A<L1<B).

Next, in step S216, the CPU 82 of the drone control device 80 determines whether the following flight control has been changed to the handing control by the function of the following flight control unit 110.

When it is determined in the negative in step S216, the CPU 82 returns to step S214 and performs the following flight control.

When it is determined in the affirmative in step S216, the CPU 82 ends the following flight process (transitions to the handing control).

Avoidance Process

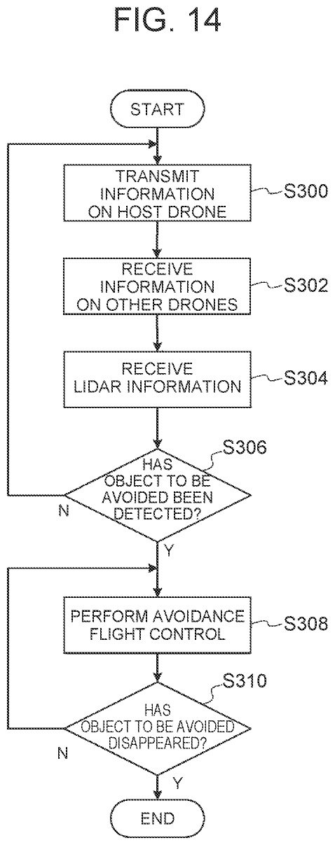

Next, an avoidance process of the drone 12 will be described with reference to the flowchart of FIG. 14. This process is constantly performed while the drone 12 is flying.

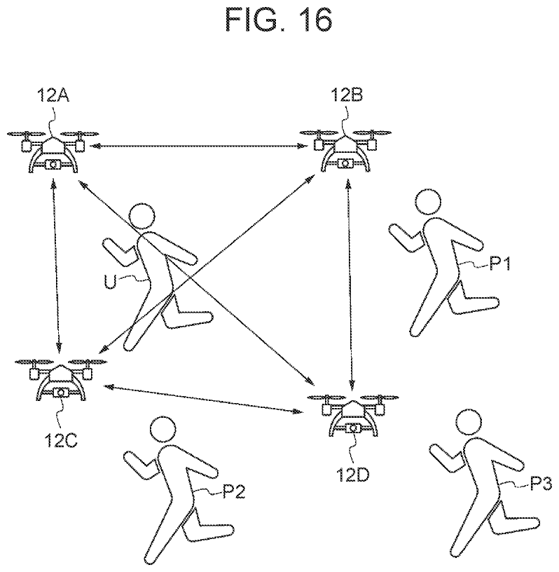

A case will be described where, as shown in FIG. 16, in the vicinity of the drone 12 used by the user U (the drone 12A in FIG. 16), there are persons P1 to P3 other than the user U and the drones 12B to 12D used by the persons P1 to P3, respectively, for movement support are flying.

The drones 12 used for movement support (e.g., the drones 12A to 12D in FIG. 16) are paired with one another by Bluetooth (R) at the time of shipment or provision of a service. Therefore, the drones 12A to 12D can transmit and receive information from and to one another (see the arrows in FIG. 16) when they approach one another within a communicable range as shown in FIG. 16.

When, in this state, the persons P1 to P3 other than the user U and the drones 12B to 12D used by the persons P1 to P3, respectively, for movement support approach the drone 12A used by the user U, the drones may come into contact with each other or the drone 12A and the persons P1 to P3 may come into contact with each other.

In step S300 of FIG. 14, the CPU 82 of the drone control device 80 of the drone 12A transmits drone information including current position information, speed information, and acceleration information on the drone 12A to the other drones 12B to 12D with which the drone 12A is paired by Bluetooth (R) by the function of the drone information transmission-reception unit 112.

In step S302, the CPU 82 of the drone control device 80 receives drone information including current position information, speed information, and acceleration information on each of the other drones 12B to 12D with which the drone 12A is paired by Bluetooth (R) from these drones 12B to 12D by the function of the drone information transmission-reception unit 112.

Further, in step S304, the CPU 82 of the drone control device 80 detects the distances between the persons P1 to P3 and the drone 12A using the lidar 70 by the function of the lidar information acquisition unit 114.

Subsequently, in step S306, the CPU 82 of the drone control device 80 determines whether there is another drone or a person other than the user U (an object to be avoided by the drone 12A) with whom the drone 12A may collide by the function of the avoidance determination unit 116.

For example, when the drone 12A and the other drones 12B to 12D communicate with each other and it is determined that the drone 12A and one of the other drones 12B to 12D may come into contact with each other based on information on the position, speed, and acceleration of each of the drones 12A to 12D, this drone is detected as an object to be avoided.

When the distance between the drone 12A and one of the persons P1 to P3 other than the user U becomes shorter than a set distance based on surroundings information detected by the lidar 70, this person is detected as an object to be avoided.

When it is determined in the negative in step S306, the CPU 82 returns to step S300.

When it is determined in the affirmative in step S306, in step S308, the CPU 82 of the drone control device 80 performs the avoidance flight control of the drone 12 by the function of the avoidance flight control unit 118.

Specifically, the drone control device 80 cancels the following flight control of making the drone 12 fly within a predetermined range from the user U, and performs the avoidance flight control such that the drone 12 is kept at a predetermined distance or a greater distance from the person or the drone that is an object to be avoided.

For example, in FIG. 16, when the drone 12B may collide with the drone 12A, the drone 12A and the drone 12B communicate with each other by Bluetooth (R) and the avoidance flight control of each of the drone 12A and the drone 12B is performed so as to maintain a state where these drones 12A, 12B are kept at a predetermined distance or a greater distance from each other. Thus, the drone 12A is prevented from colliding with the drone 12B.

Similarly, also when the person P1 has approached the drone 12A up to a position within a set distance, the avoidance flight control of the drone 12A is performed in the direction of moving away from the person P1, so that the drone 12A is reliably prevented from coming into contact with the person P1.

Next, in step S310, the CPU 82 of the drone control device 80 determines whether the object to be avoided has disappeared as a result of the avoidance flight control by the function of the avoidance determination unit 116.

Specifically, it is determined whether there is no longer any other drone or person with whom the drone 12A may collide based on drone information received from the other drones 12B to 12D and surroundings information detected from the lidar 70.

When it is determined in the negative in step S310, the CPU 82 returns to step S308.

When it is determined in the affirmative in step S310, the CPU 82 ends the control.

Handing Process

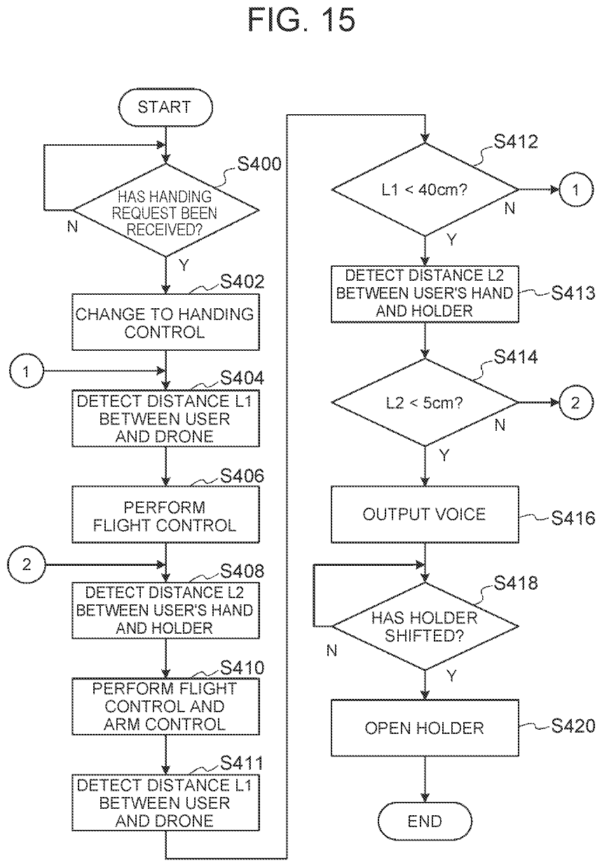

In the following, a handing process of the drone 12 will be described with reference to the flowchart of FIG. 15.

First, in step S400, the CPU 82 of the drone control device 80 determines whether a drink handing request has been received from the user U by the function of the request detection unit 120.

Here, during a following flight of the drone 12, driving of the first stepping motor 50 to the third stepping motor 54 is controlled such that the 3D camera 72 provided at the leading end of the arm 44B of the holder 42 is always aimed at the user U and images the user U. The CPU 82 of the drone control device 80 also detects whether the user U has assumed a specific pose that means a handing request from an image captured by the 3D camera by the function of the request detection unit 120. One example of the specific pose is the user U raising his or her hand with the left arm forming an L-shape.

When it is determined in the negative in step S400, the CPU 82 waits until a handing request is detected.

When it is determined in the affirmative in step S400 (it is detected that the user U is assuming the specific pose from an image captured by the 3D camera 72), the CPU 82 moves to step S402.

In step S402, the CPU 82 of the drone control device 80 transitions from the following flight control to the handing control in the set mode by the function of the handing control unit 121.

In this case, driving of the rotor motors 24 and the first stepping motor 50 to the third stepping motor 54 is controlled such that the 3D camera 72 is aimed in the direction of the hand H of the user U.

Next, in step S404, the CPU 82 of the drone control device 80 detects the distance L1 between the drone 12 and the user U (see FIG. 17) based on surroundings information detected by the lidar 70 by the function of the handing control unit 121.

Subsequently, in step S406, the CPU 82 of the drone control device 80 controls the flight of the drone 12 by controlling driving of the rotor motors 24 such that the distance L1 becomes a few tens of centimeters (e.g., 40 cm) or shorter by the function of the handing control unit 121.

Next, in step S408, the CPU 82 of the drone control device 80 detects the distance L2 between the 3D camera 72 (holder 42) and the hand H of the user U (see FIG. 17) based on an image (information) captured by the 3D camera 72 by the function of the handing control unit 121.

Subsequently, in step S410, the CPU 82 of the drone control device 80 controls the flight of the drone 12 and the shift of the first arm 28 and the second arm 30 by controlling driving of the rotor motors 24 and the first stepping motor 50 to the third stepping motor 54 such that the distance L2 becomes a few centimeter (e.g., five centimeters) or shorter by the function of the handing control unit 121.

Specifically, the drone control device 80 controls the direction of the drone 12 by controlling driving of each rotor motor 24 such that (the hand H of) the user U is located in the shifting direction of the first arm 28.

Further, the drone control device 80 outputs driving signals to the first stepping motor 50 and the second stepping motor 52 such that the first joint 32 and the second joint 34 of the first arm 28 rotate in the directions of arrows A, B. Thus, the holder 42 mounted at the leading end of the first arm 28 is moved to a position within a few centimeters from the hand H of the user U.

Meanwhile, the drone control device 80 controls driving of the third stepping motor 54 so as to maintain the holder 42 in a horizontal state regardless of shift of the first arm 28.

While the user U is walking or running, the position of the hand H of the user U shifts constantly relatively to his or her upper body. A position in which the hand H of the user U is located farthest frontward relatively to the upper body as the user U swings his or her arm is regarded as the position of the hand H of the user U.

During this handing control, the CPU 82 of the drone control device 80 controls the flight of the drone 12 so as to fly alongside the user U who is a runner by the function of the handing control unit 121. Thus, the relative speed between the user U and the drone 12 is reduced, which makes it easier to adjust the distances L1, L2.

In this case, by the function of the handing control unit 121, the CPU 82 of the drone control device 80 outputs a driving signal to the fourth stepping motor 56 such that the second arm 30 rotates and shifts in the opposite direction from the first arm 28 as seen in a plan view to thereby cancel the moment acting on the machine main body 20 of the drone 12 due to shift of the first arm 28. As a result, the moment that acts on the machine main body 20 of the drone 12 due to shift of the first arm 28, the holder 42, and the drink (cup 58) is canceled (reduced) by the rotational moment due to shift of the second arm 30 and the counterweight 64, so that the load of control for maintaining the posture of the drone 12 is relieved.

Next, in step S411, the CPU 82 of the drone control device 80 detects the distance L1 between the drone 12 and the user U again based on surroundings information detected by the lidar 70 by the function of the handing control unit 121.

Subsequently, in step S412, the CPU 82 of the drone control device 80 determines whether this distance L1 has become shorter than a few tens of centimeters (e.g., 40 cm) by the function of the handing control unit 121.

When it is determined in the negative in step S412, the CPU 82 returns to step S404.

When it is determined in the affirmative in step S412, the CPU 82 moves to step S413.

In step S413, the CPU 82 of the drone control device 80 detects the distance L2 between the 3D camera 72 (holder 42) and the hand H of the user U again based on an imaging signal of the 3D camera 72 by the function of the handing control unit 121.

In step S414, the CPU 82 of the drone control device 80 determines whether this distance L2 has become shorter than a few centimeters (e.g., five centimeters) by the function of the handing control unit 121.

When it is determined in the negative in step S414, the CPU 82 returns to step S408.

When it is determined in the affirmative in step S414, the CPU 82 moves to step S416.

In step S416, the CPU 82 of the drone control device 80 urges the user U to take the cup 58 out of the holder 42 by outputting a voice saying, “Please take the drink,” from the speaker 74 provided in the drone 12 by the function of the handing control unit 121.

Next, in step S418, the CPU 82 of the drone control device 80 determines whether an amount of upward shift (shift signal) of the arms 44A, 44B of the holder 42 that is equal to or larger than the threshold value has been detected by the shift sensor 76 by the function of the handing control unit 121. The basis for this determination is that, when the user U holds the cup 58, the load acting on the arms 44A, 44B decreases and the arms 44A, 44B shift upward.

When it is determined in the negative in step S418, the CPU 82 waits until it is determined in the affirmative.

When it is determined in the affirmative in step S418, in step S420, the CPU 82 of the drone control device 80 outputs a driving signal to the fourth stepping motor 56 so as to move the arms 44A, 44B of the holder 42 away from each other and thereby allow the cup 58 to be taken out of the holder 42 by the function of the handing control unit 121.

Thus, the user U can take the drink (cup 58) out of the holder 42.

Changes According to Attribute

When the case where the attribute of the user U is a runner and the case where it is a walker are compared, a runner moves at a higher speed as well as swings his or her arms and moves his or her upper body up and down to a greater extent than a walker. In the case of a runner, therefore, the range of the set distance from the user U during the following flight control is set to be relatively wide (such that the user U is relatively distanced from the drone 12) compared with the case of a walker.

During the handing control, since a runner moves at a high speed and it is difficult to hand a drink to the user U with the drone 12 hovering, the drone 12 is made to fly alongside the user U so as to reduce the relative speed between the user U and the drone 12, and the holder 42 is kept in a position a few centimeters before the hand H of the user U to allow the drink to be handed.

Further, when the attribute of the user U is a person with visual impairment, since the user U has difficulty visually recognizing the drink during the handing control compared with when the user U is a person without visual impairment, a predetermined position that is a fixed position relative to the upper body of the person with visual impairment is set as a position at which the drink is handed. A person with visual impairment can learn the handing position through prior training such that a drink (cup 58) can be handed from the holder 42 of the drone 12.

Moreover, when whether the user U is right-handed or left-handed is registered beforehand as an attribute, the drone 12 can be set so as to hand a drink to the dominant hand when handing it.

Effects

As has been described above, in the movement support system 10, the user U only has to start the application on the mobile terminal 18 and select an available drone 12 to make the selected drone 12 fly so as to follow the user U while holding the cup 58 containing a drink by the holder 42.

When the drone 12 flies so as to follow the user U, the distance L1 between the drone 12 and the user U is accurately detected based on surroundings information detected by the lidar 70 of the drone 12. Thus, the drone 12 can follow the user U while keeping the relative positional relationship with the user U within a fixed range, without coming into contact with the user U.

When handing a drink from the drone 12 to the user U, the drone 12 is brought close to the user U until the distance L1 to the user U decreases to be within the range of a few tens of centimeters based on a detection signal of the lidar 70, and then the holder 42 is brought close to the hand H of the user U until the distance L2 to the hand H decreases to be within the range of a few centimeters based on an image captured by the 3D camera 72. Thus, the user U can easily receive the drink (cup 58) from the holder 42.

Attribute information on the user U is transmitted from the server 16 to the drone control device 80 of the drone 12, so that the drone control device 80 can set the mode according to the attribute information and perform the following flight control based on the mode.

For example, when the user U is a person with visual impairment, the user U cannot visually recognize the drone 12. Therefore, the person-with-visual-impairment mode is set in which the drone is made to fly so as to follow the user U at a greater distance during the following flight control than in the case of a person-without-visual-impairment. Thus, the user U and the drone 12 can be reliably prevented from coming into contact with each other.

In the case where the user U is a runner, the runner mode is set in which the drone 12 is made to fly so as to follow the user U at a greater distance from the user U during a following flight than in the case of a walker. Thus, the drone 12 and the user U who moves at a higher speed and swings his or her arms to a greater extent than a walker can be reliably prevented from coming into contact with each other.

Further, when the dominant hand of the user U is the left hand, the left hand mode in which the drone 12 flies on the left side of the user U is set, so that the holder 42 can be quickly shifted to the front side of the left hand that is the dominant hand during the handing control.

Also during the handing control, the control can be changed based on the attribute of the user U.

When the user U is a person with visual impairment, since the user U cannot visually recognize the position of the holder 42, the person-with-visual-impairment mode is set in which a drink is handed at the predetermined position that is a fixed position relative to the upper body of the user U. As the holder 42 is moved to the predetermined position, the drink can be handed to the user U who is a person with visual impairment.

In the case of the person-with-visual-impairment mode, therefore, the 3D camera 72 images the upper body of the user U instead of the hand H of the user U, and driving of the first stepping motor 50 and the second stepping motor 52 is controlled based on a captured image of the upper body. Thus, the holder 42 can be shifted to the predetermined position that is a fixed position relative to the upper body of the user U (e.g., a position 20 cm before the right shoulder of the user U).

When the user U is a runner, since the user U who is a runner moves at a higher speed than a walker etc., the handing control is performed while making the drone 12 fly alongside the user U. Thus, the relative speed between the holder 42 holding a drink (cup 58) and the user U is reduced, allowing the user U to easily take the drink.

Further, the drones 12 (e.g., the drones 12A to 12D) used in the movement support system 10 are paired with one another by Bluetooth (R) and can communicate with one another. Thus, the drones 12A to 12D that have approached one another can communicate their respective pieces of information on the position, speed, and acceleration with one another.

When a risk of a collision between drones is detected based on this information, the following flight control or the handing control is interrupted and the drones that have approached each other perform an avoidance flight so as to keep a fixed distance from each other while communicating with each other. Thus, a collision between drones is reliably avoided even when there is a plurality of drones flying in the vicinity.

In particular, each drone 12 detects (estimates) its own position by the RTK-GNSS, and thus the current position of the drone 12 is accurately detected (with the error being within the range of a few centimeters). Therefore, by communicating with the other drones 12B to 12D, the drone 12A can correctly grasp the positional relationships with the other drones 12B to 12D and reliably avoid a collision with the other drones 12B to 12D.

Also when the persons P1 to P3 other than the user U have approached up to a position within the set distance from the drone 12 (12A) based on surroundings information detected by the lidar 70, the drone 12 interrupts the following flight control or the handing control and performs the avoidance flight control of moving away from the person. Thus, the drone 12 is also prevented from coming into contact with other persons.

Further, the drone 12 is provided with the first arm 28, and the holder 42 holding the cup 58 can be brought close to the user U by controlling driving of the first stepping motor 50 and the second stepping motor 52.

In this case, the distance between the drone 12 and the user U is adjusted based on the distance L1 between the drone 12 and the user U detected by the lidar 70, so that the drone 12 can be brought close to the user U up to a position within a few tens of centimeters, for example, within 40 cm from the user U.

Further, the drone 12 has the 3D camera 72 provided at the leading end of the arm 44B of the holder 42, and the distance L2 between the hand H of the user U and the holder 42 is accurately detected based on an image captured by the 3D camera 72. Therefore, the holder 42 can be positioned within the range of a few centimeters, for example, five centimeters from the hand H of the user U, and thus the drone 12 exhibits excellence in handing a drink to the user U.

The drone 12 is provided with the second arm 30 with the counterweight 64 mounted at the leading end, and the second arm 30 can be shifted in the opposite direction from the first arm as seen in a plan view by driving the fifth stepping motor 66. As a result, the rotational moment acting on the machine main body 20 of the drone 12 due to shift of the first arm 28, the holder 42, the cup 58 (drink), etc. during the handing control can be canceled by the rotational moment due to shift of the counterweight 64 and the second arm 30 to thereby relieve the load of controlling the posture of the drone 12 during the handing control.

Others

The movement support system 10 according to the above embodiment is configured such that the drone 12 flies so as to follow the user U while holding a drink (cup 58) and hands the drink to the user U at a desired timing. However, the present disclosure is not limited to this example.

First, the moving body that follows the user U is not limited to an unmanned aircraft such as a drone, and the moving body is not particularly limited as long as it can autonomously follow the user U. For example, the moving body may be a traveling body that moves autonomously over the ground.

While the movement support in the embodiment is handing a drink (cup 58) to a user U who is moving, the movement support is not limited to this example.

For example, an article handed to the user U may be a food other than a drink or an article other than a food. For example, the article may be an article of clothing, such as an article of cold-weather clothing or a rainwear.

Further, the movement support is not limited to handing an article from the moving body to the user U, and the movement support is not particularly limited as long as it is following and supporting the user U using a moving body. For example, a configuration may be adopted in which a moving body follows a user U who is a runner and mist is sprayed from the moving body onto the user U to cool the user U.

In the movement support system 10, the contents of the support, namely the contents of the following control and the handing control for the user U in the embodiment, are changed according to the attribute of the user U. It is also conceivable to change the contents of other types of support according to the attribute of the user U.

For example, when a coffee shop provides a drink to a user U, the container of the drink may be changed according to the attribute of the user U. For example, when the user U is a runner, the drink may be provided in a bottle with a straw such that the user U can drink it without spilling, and when the user U is a walker, the drink may be provided in a cup with a lid. Similarly, when the user U is a person with visual impairment, the drink may be provided in a bottle with a straw, allowing for the possibility that the user U may spill the drink when receiving it.

Further, while in the embodiment the distance L1 between the drone 12 and the user U is detected by the lidar 70, the distance L1 may instead be detected based on position information on the drone 12 and position information on the mobile terminal 18 (user U) detected by the RTK-GNSS.

Moreover, while in the embodiment the drink is provided from the drone 12 to the user U when the user U makes a handing request by assuming the specific pose, the present disclosure is not limited to this example. For example, a drink may be provided to the user U by performing the handing control as soon as the drone 12 reaches a position within a predetermined range from the user U. Or a drink may be provided to the user U after a predetermined time has elapsed.

During the handing control of the drone 12, the first arm 28 with the holder 42 provided at the leading end is shifted and the second arm 30 with the counterweight 64 mounted at the leading end is shifted in the opposite direction from the first arm so as to cancel the rotational moment due to shift of the first arm and thereby relieve the control load of maintaining the posture of the drone 12. In some embodiments, the counterweight 64 and the second arm 30 may be omitted.

The mechanism for shifting the holder 42 during the handing control of the drone 12 is not limited to that of the embodiment. The mechanism is not particularly limited as long as it shifts the holder 42 (drink) toward the user. The same applies to the configuration of the holder 42.

Further, while in the embodiment the movement support service is started when use request information is transmitted from the mobile terminal 18 of the user U to the server 16, the present disclosure is not limited to this example.

Moreover, while the attribute information on the user U is input and stored beforehand in the server 16, the present disclosure is not limited to this example.

For example, it is possible that a service providing company may apply this movement support to buying a drink to take out at a coffee shop. A user U may be imaged by the 3D camera 72 of the drone 12 of the service providing company (coffee shop) to detect an amount of characteristic of the user U. The user U who is leaving the coffee shop may be detected based on this amount of characteristic from the image captured by the 3D camera 72, and the drone 12 may fly so as to follow the user U and hand a drink to the user U.

In this case, a configuration can be adopted in which an employee of the coffee shop or the user U inputs the attribute information on the user U into an input device at the shop when buying a drink and the drone 12 acquires this attribute information on the user U.

When this configuration is adopted, the movement support system 10 does not need the mobile terminal 18 with which the user U requests to use the movement support and the server 16 that acquires attribute information on the user U. In some embodiments, the mobile terminal 18 and the server 16 may be omitted from the movement support system 10.

In this case, the attribute information acquisition unit 150 provided in the server control device 136 is provided in the drone control device 80.

In the embodiment, the drones 12A to 12D are paired with one another by Bluetooth (R) so as to be communicable. However, the communication method is not limited to Bluetooth (R) as long as the drones can communicate with one another.

While the movement support system according to the embodiment has been described above, it should be understood that the present disclosure can be implemented in various forms without departing from the gist of the disclosure.

The processes that the CPU have executed by reading software (programs) in the above embodiment may be executed by various processors other than the CPU. Examples of processors in this case include a programmable logic device (PLD), such as a field-programmable gate array (FPGA), of which the circuit configuration can be changed after manufacturing, and a dedicated electric circuit, such as an application-specific integrated circuit (ASIC), that is a processor having a circuit configuration specifically designed to execute a specific process. Further, a display process may be executed by one of these various processors or a combination of two or more processors of the same type or different types (e.g., a combination of a plurality of FPGAs, or a combination of a CPU and an FPGA). The hardware structure of these various processors is more particularly an electric circuit combining circuit elements, including a semiconductor element.

Further, while the configuration in which various pieces of data are stored in the storage is adopted in the above embodiment, the present disclosure is not limited to this example. For example, recording media, such as a compact disk (CD), a digital versatile disk (DVD), and a universal serial bus (USB) memory, may be used as storage units. In this case, various programs, data, etc. are stored in these recording media.

What is claimed is:

1. A movement support system in which a moving body follows a moving user to support the user, the movement support system comprising:
an attribute information acquisition unit that acquires attribute information on the user;
a mode setting unit that sets a mode of the moving body based on the attribute information; and
a following support control unit that makes the moving body follow the user and support the user based on the selected mode.

2. The movement support system according to claim 1, wherein the attribute information is at least one of whether the user is a walker or a runner and whether the user is a person with visual impairment or a person without visual impairment.

3. The movement support system according to claim 1, wherein the moving body is an unmanned aircraft.

4. The movement support system according to claim 1, wherein the support is following the user by the moving body holding an article and handing the article from the moving body to the user.

5. The movement support system according to claim 4, wherein:
the moving body includes:
a holding part that holds an article; and
a movable part capable of shifting the holding part toward the user.

6. The movement support system according to claim 5, wherein, when the attribute information is a person with visual impairment, the holding part is shifted to a predetermined position that is a fixed position relative to an upper body of the user when the article is handed from the moving body to the user.

7. The movement support system according to claim 5, wherein:
the moving body is an unmanned aircraft; and
the moving body includes:
a first arm of which one end is mounted to the moving body and the other end is capable of shifting so as to approach the user;
a holder that is mounted at the other end of the first arm and capable of holding the article;
a second arm of which one end is mounted to the moving body and the other end is capable of shifting toward the opposite side from the first arm as seen in a plan view; and
a counterweight mounted at the other end of the second arm.
